(19) United States
(12) Patent Application Publication
(10) Pub. No.: US 2022/0301330 A1
(43) Pub. Date: Sep. 22, 2022

(54) INFORMATION EXTRACTION SYSTEM AND NON-TRANSITORY COMPUTER READABLE RECORDING MEDIUM STORING INFORMATION EXTRACTION PROGRAM

(71) Applicant: KYOCERA Documents Solutions Inc., Osaka-shi (JP)

(72) Inventor: Hidenori SHOJI, Osaka -shi (JP)

(21) Appl. No.: 17/691,340

(22) Filed: Mar. 10, 2022

(30) Foreign Application Priority Data
Mar. 19, 2021 (JP) 2021-045884

(51) Int. Cl. G06V 30/19; G06V 30/413; G06V 30/416

(52) U.S. Cl. CPC G06V 30/19107; G06V 30/413; G06V 30/416; G06V 30/19167; G06V 30/19147

(57) ABSTRACT

An information extraction system divides learning data items into main clusters by performing clustering on a set of the learning data items for use in generation of clustering models that are information extraction models for extracting information from invoice data and generates the different information extraction models for the different main clusters by performing learning using the learning data items for the individual main clusters.

### INCORPORATION BY REFERENCE

This application is based upon, and claims the benefit of priority from, corresponding Japanese Patent Application No. 2021-045884 filed in the Japan Patent Office on Mar. 19, 2021, the entire contents of which are incorporated herein by reference.

### BACKGROUND

### Field of the Invention

The present disclosure relates to an information extraction system that extracts a value of a specific item from data of a document and a non-transitory computer readable recording medium storing an information extraction program.

### Description of Related Art

Typically, information extraction systems that extract information from data of a document using an information extraction model for extracting information from data of a document have been used.

### SUMMARY

According to an aspect of the present disclosure, an information extraction system includes a document clustering section that performs clustering on a set of learning data items to be used to generate information extraction models for extracting information from document data to divide each of the learning data items into any of main clusters; and a model learning section that generates the information extraction models for the main clusters, respectively, by performing learning using the learning data items for the main clusters, respectively.

According to another aspect of the present disclosure, a non-transitory computer readable recording medium storing an information extraction program causes a computer to realize a document clustering section that divides learning data items into main clusters by performing performs clustering on a set of the learning data items to be used to generate information extraction models for extracting information from document data to divide each of the learning data items into any of main clusters; and a model learning section that generates the different information extraction models for the different main clusters, respectively, by performing learning using the learning data items for the individual main clusters, respectively.

### BRIEF DESCRIPTION OF THE DRAWINGS

FIG. 1 is a block diagram illustrating an information extraction system according to an embodiment of the present disclosure;

FIG. 2 is a diagram illustrating an example of an information extraction model stored in a storage section illustrated in FIG. 1;

FIG. 3 is a flowchart of an operation of the information extraction system illustrated in FIG. 1 performed when a cluster model is to be generated;

FIGS. 4A and 4B are diagrams illustrating a process of dividing a set of learning data items into main clusters in the operation illustrated in FIG. 3;

FIGS. 5A, 5B, and 5C are diagrams illustrating an image of a process of separating sub clusters from the main clusters in the operation illustrated in FIG. 3;

FIG. 6 is a diagram illustrating a process of selecting learning data item to be used in generation of a cluster model in the operation illustrated in FIG. 3;

FIG. 7 is a flowchart of an operation of the information extraction system illustrated in FIG. 1 when a value of a specific item is extracted from invoice data;

FIG. 8 is a flowchart of a portion of the operation of the information extraction system illustrated in FIG. 1 when the cluster model is to be updated; and

FIG. 9 is a flowchart of an operation following the operation illustrated in FIG. 8.

### DETAILED DESCRIPTION

Hereinafter, an embodiment of the present disclosure will be described with reference to the accompanying drawings.

First, a configuration of an information extraction system according to the embodiment of the present disclosure will be described.

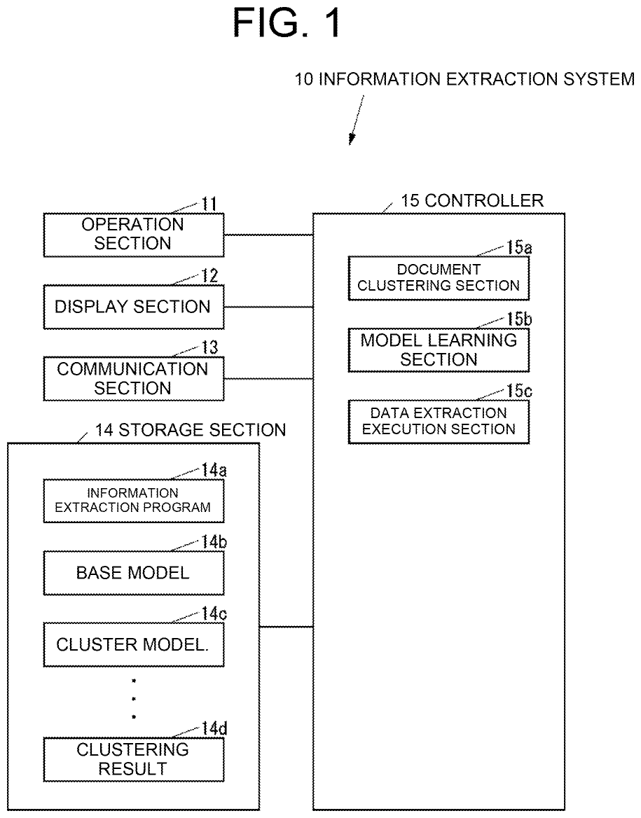

FIG. 1 is a block diagram illustrating an information extraction system 10 according to this embodiment.

As illustrated in FIG. 1, the information extraction system 10 includes an operation section 11 as an operation device, such as a keyboard or a mouse, through which various operations are input, a display section 12 as a display device, such as a liquid crystal display (LCD), for displaying various types of information, a communication section 13 as a communication device for communicating with external apparatuses over a network, such as a LAN or the Internet or with no networks but directly through a wired or wireless connection, a storage section 14 as a non-volatile storage device, such as a semiconductor memory or a hard disk drive (HDD), for storing various types of information, and a controller 15 that controls the entire information extraction system 10. The information extraction system 10 may be constituted by, for example, a PC (Personal Computer) or a server or may be constituted by an image forming apparatus, such as a dedicated printer.

The storage section 14 stores an information extraction program 14a for extracting information from data of an invoice (hereinafter referred to as “invoice data”) using an information extraction model for extracting information from invoice data as a document. The information extraction program 14a may be installed in the information extraction system 10 at a manufacturing stage of the information extraction system 10, may be additionally installed in the information extraction system 10 from an external storage medium, such as a universal serial bus (USB) memory, or may be additionally installed in the information extraction system 10 from the network, for example.

The storage section 14 stores an information extraction model 14b that has learnt a plurality of formats of invoices (hereinafter referred to as a “base model”). The base model 14b may be prepared by a person who provides the information extraction system 10 to users of the information extraction system 10.

The storage section 14 may store information extraction models 14c for individual main clusters described below (hereinafter referred to as “cluster models”). Invoice data that is a target of extraction of a value using the cluster model (hereinafter referred to as “extraction target data”) includes characters in an invoice and features other than characters in the invoice. The features other than characters in the invoice include coordinates of the individual characters in the invoice. Furthermore, the features other than characters in the invoice may include, for example, images in the invoice and coordinates of the individual images in the invoice. The characters in the invoice and coordinates of the individual characters in the invoice may be obtained, for example, by performing an OCR (Optical Character Recognition) process on the images of the invoice. The images in the invoice and the coordinates of the individual images in the invoice may be obtained by a system that is capable of obtaining the images and the coordinates of the individual images from the images of the invoice.

The storage section 14 may store a result 14d of the clustering of the main clusters (hereinafter referred to as a “clustering result”).

The controller 15 includes, for example, a CPU (Central Processing Unit), a ROM (Read Only Memory) storing programs and various data, and a RAM (Random Access Memory) as a memory used as a work area of the CPU of the controller 15. The CPU of the controller 15 executes the programs stored in the storage section 14 or the ROM of the controller 15.

By executing the information extraction program 14a, the controller 15 realizes a document clustering section 15a that performs clustering on invoice data, a model learning section 15b that generates a cluster model, and a data extraction execution section 15c that extracts a value of a specific item from the invoice data using the cluster model.

As an algorithm used for clustering in the document clustering section 15a, an algorithm which can automatically determine the number of clusters, such as DBSCAN, g-means, the Elbow method, is employed. As the features used for clustering in the document clustering section 15a, word vectors and word coordinates are employed, for example. A one-hot vector, a tf-idf, word2vec, or the like is employed to represent the word vectors, for example.

As an algorithm used in the model learning section 15b to generate a cluster model, an algorithm based on an algorithm using natural language processing, such as LSTM or Transformer, is employed. Text information and coordinates of characters are employed as the features used to generate a cluster model in the model learning section 15b, for example.

Examples of a document from which values are to be extracted by the data extraction execution section 15c include a formatted document in which positions of descriptions of values do not differ from document to document, and a semi-formatted document in which positions of descriptions of values may differ from document to document, but an unformatted document is not included.

As an algorithm used to calculate a distance of data in the document clustering section 15a, the model learning section 15b, and the data extraction execution section 15c, Cosine distance, Manhattan distance, or Euclidean distance is employed, for example.

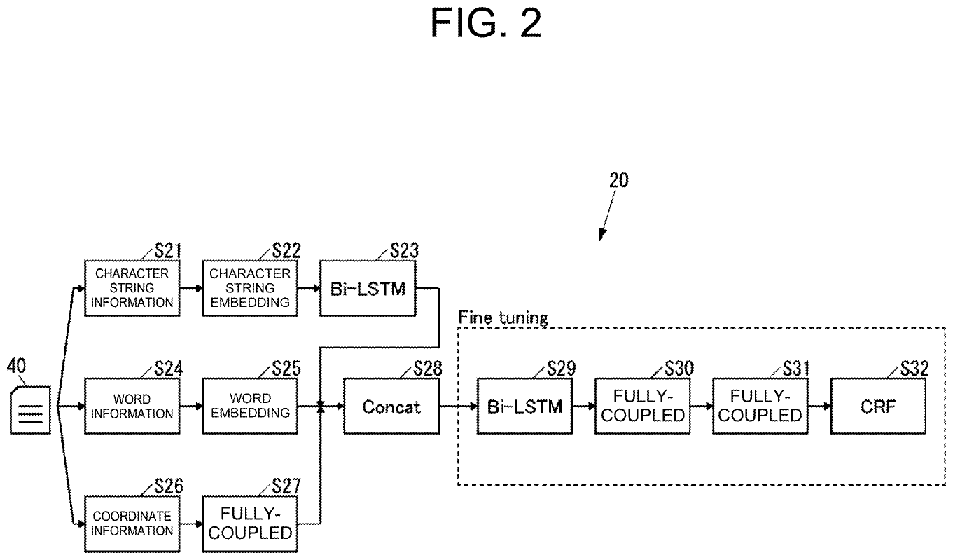

FIG. 2 is a diagram illustrating an example of an information extraction model 20 stored in the storage section 14.

The information extraction model 20 shown in FIG. 2 obtains individual characters based on “characters in the invoice” in the extraction target data 40 (S21), assigns vector information based on the individual characters to the corresponding characters obtained in step S21 (S22), and inputs an output of step S22 into Bi-LSTM (S23).

Furthermore, the information extraction model 20 obtains individual words based on “characters in the invoice” in the extraction target data 40 (S24), and assigns vector information based on the individual words to the corresponding words obtained in step S24 (S25).

Furthermore, the information extraction model 20 obtains coordinates of the individual words based on “coordinates of the individual characters in the invoice” in the extraction target data 40 (S26), and inputs the coordinates of the individual words obtained in step S26 to a fully coupled layer (S27).

Then, the information extraction model 20 concatenates the outputs of step S23, step S25, and step S27 (S28).

Thereafter, the information extraction model 20 inputs an output of step S28 into Bi-LSTM (S29), inputs an output of step S29 to the fully coupled layer (S30), inputs an output of step S30 to the fully coupled layer (S31), and inputs an output of step S31 to CRF (S32).

Next, operation of the information extraction system 10 will be described.

First, an operation of the information extraction system 10 performed when a cluster model is to be generated will be described.

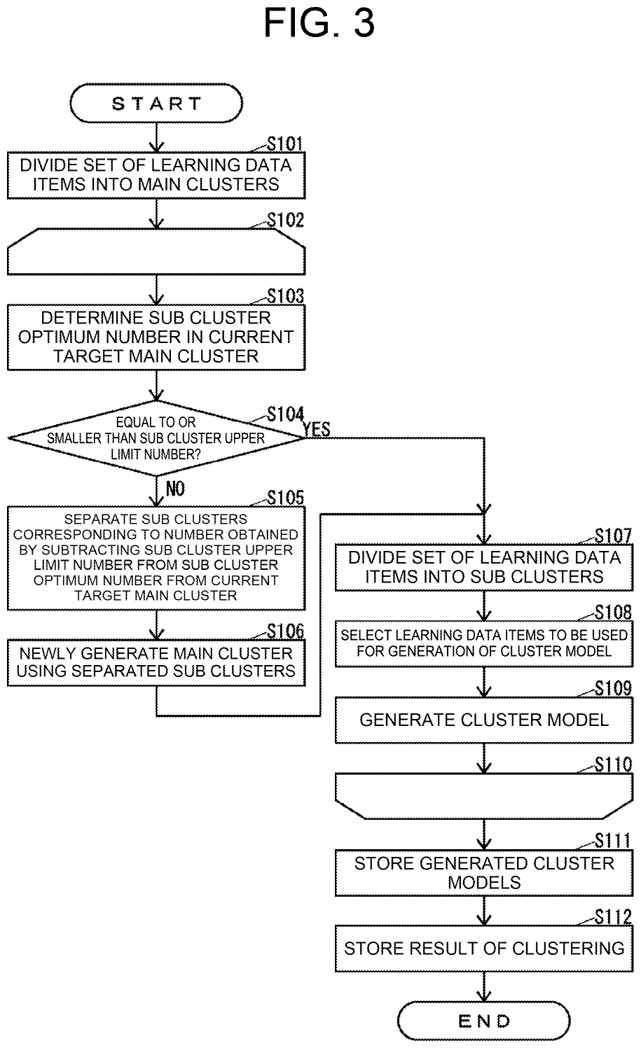

FIG. 3 is a flowchart of the operation of the information extraction system 10 performed when a cluster model is to be generated.

The user may prepare a set of learning data items for generating cluster models and instruct the information extraction system 10 to perform learning using the prepared set of learning data items from the operation section 11 or from a computer not shown in the figure via the communication section 13. Here, a learning data item is invoice data, for each invoice, including characters in an invoice, features other than characters in the invoice, and a correct label for an item desired, by the user, to be extracted from the invoice. The features other than characters in the invoice include coordinates of the individual characters in the invoice. Furthermore, the features other than characters in the invoice may include, for example, images in the invoice and coordinates of the individual images in the invoice. Examples of an item desired, by the user, to be extracted from the invoice include a billing address, a billing date, a closing date, and a billing amount, when a document is an invoice. The correct label for the item desired, by the user, to be extracted from the document is a value selected by the user from the characters in the invoice and the features other than the characters in the invoice. The characters in the invoice and coordinates of the individual characters in the invoice may be obtained, for example, by performing an OCR process on an image of the invoice. The images in the invoice and the coordinates of the individual images in the invoice may be obtained by a system that is capable of obtaining the images and the coordinates of the individual images from the images of the invoice.

The controller 15 of the information extraction system 10 performs an operation illustrated in FIG. 3 when learning using a set of learning data items is instructed.

As illustrated in FIG. 3, the document clustering section 15a performs clustering on the set of learning data items to divide the learning data items into main clusters (S101).

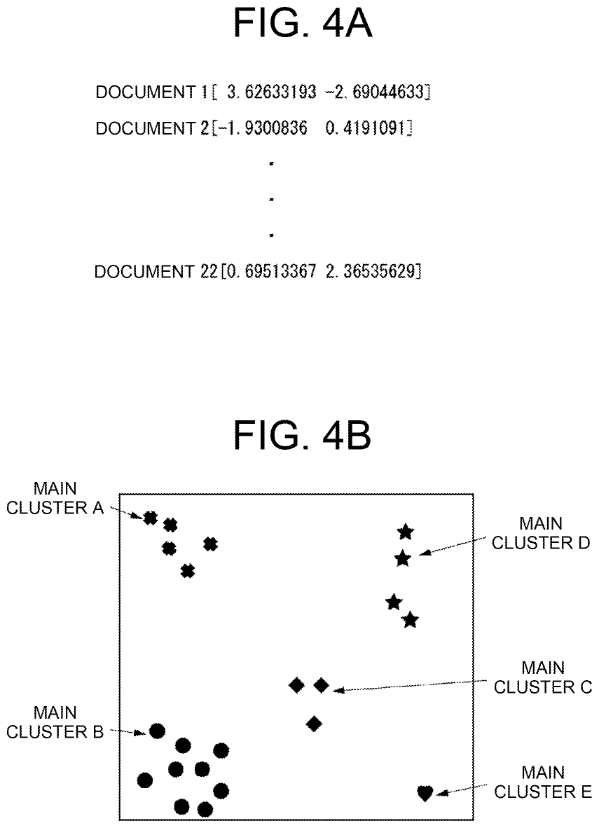

FIGS. 4A and 4B are diagrams illustrating a process of dividing the set of learning data items into main clusters in the operation illustrated in FIG. 3. In FIG. 4B, the learning data items are indicated by different marks for the different main clusters to which the learning data items belong.

As illustrated in FIGS. 4A and 4B, before performing the clustering on the set of learning data items, the document clustering section 15a vectorizes the learning data items as illustrated in FIG. 4A so that the characters in the target invoice of the learning data items can be compared among the learning data items.

Subsequently, the document clustering section 15a divides the individual learning data items into main clusters A to E as illustrated in FIG. 4B by performing clustering on the set of learning data items (S101).

As illustrated in FIG. 3, the controller 15 determines, after the process in step S101, one of the main clusters that have not yet been subjected to the process in step S103 in a current execution of the operation illustrated in FIG. 3 as a target (S102).

Thereafter, the document clustering section 15a determines an optimum number of sub clusters (hereinafter referred to as a “sub cluster optimum number”) in a current target main cluster by a cluster number automatic estimation method (S103).

Subsequently, the document clustering section 15a determines whether the sub cluster optimum number determined in step S103 is within an upper limit number of sub clusters (hereinafter referred to as a “sub cluster upper limit number”) (S104). The sub cluster upper limit number is, for example, five in this embodiment.

When determining in step S104 that the sub cluster optimum number determined in step S103 is not equal to or smaller than the sub cluster upper limit number, the document clustering section 15a separates a number of the sub clusters corresponding to a number obtained by subtracting the sub cluster upper limit number from the sub cluster optimum number determined in S103 from the current target main cluster (S105). Here, the document clustering section 15a preferentially separates, from the current target main cluster, sub clusters whose centers of gravity are far from the center of gravity of the current target main cluster. The center of gravity of a main cluster is, for example, an average value of document vectors of the learning data items that belong to this main cluster. Similarly, the center of gravity of a sub cluster is, for example, an average value of document vectors of learning data items that belong to this sub cluster.

Here, the document clustering section 15a newly generates, after the process in step S105, a main cluster using the sub clusters separated from the current target main cluster in step S105 (S106). Specifically, the document clustering section 15a determines, as a new main cluster, the sub clusters separated from the current target main cluster in step S105.

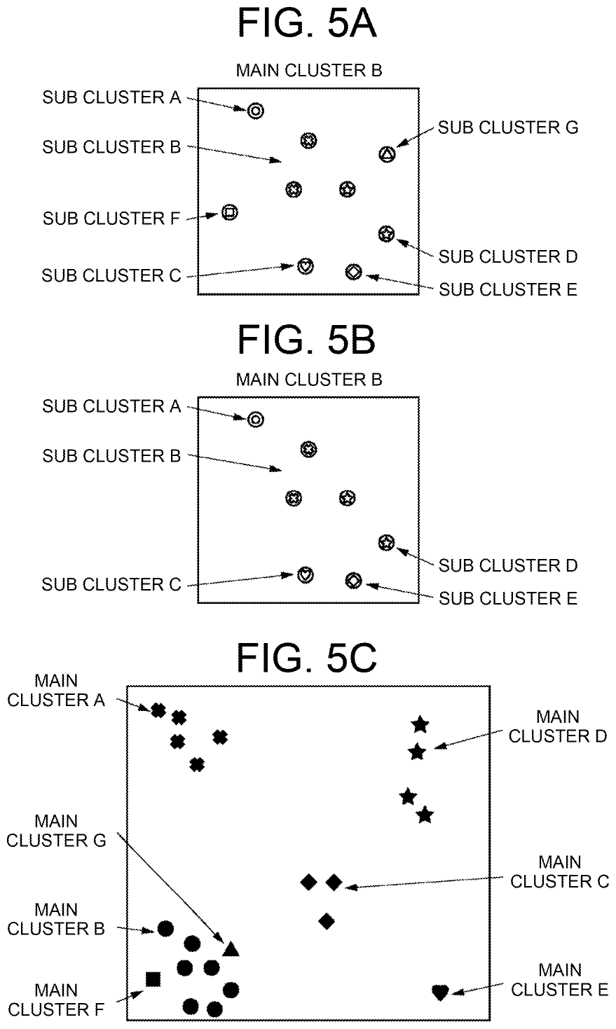

FIGS. 5A, 5B, and 5C are diagrams illustrating an image of the process of separating sub clusters from the main clusters in the operation illustrated in FIG. 3. Here the main cluster B illustrated in FIG. 4B is taken as an example. In FIGS. 5A and 5B, the learning data items are indicated by different marks for the different sub clusters to which the learning data items belong. In FIG. 5C, the learning data items are indicated by different marks for the different main clusters to which the learning data items belong.

As illustrated in FIG. 5A, the document clustering section 15a determines the sub cluster optimum number for the main cluster B (S103). As illustrated in FIG. 5A, the document clustering section 15a determines that the sub cluster optimum number in the main cluster B is seven by the cluster number automatic estimation method.

When determining that the sub cluster optimum number determined in step S103 is not equal to or smaller than the sub cluster upper limit number (NO in S104), the document clustering section 15a separates a number of the sub clusters corresponding to a number obtained by subtracting the sub cluster upper limit number from the sub cluster optimum number determined in S103 from the main cluster B as illustrated in FIG. 5B (S105). In other words, the document clustering section 15a separates the sub clusters F and G from the main cluster B. In the example illustrated in FIG. 5B, the sub cluster upper limit number is five.

Here, the document clustering section 15a newly generates, after the process in step S105, main clusters F and G using the sub clusters separated from the main cluster B in step S105 (S106) as illustrated in FIG. 5C.

As illustrated in FIG. 3, when the document clustering section 15a determines in step S104 that the optimum number determined in step S103 is equal to or smaller than the sub cluster upper limit number or when the process in step S106 is terminated, the document clustering section 15a performs clustering on the set of learning data items in the current target main cluster by the sub cluster optimum number so as to divide the individual learning data items in the current target main cluster into the sub clusters (S107).

Next, the model learning section 15b selects a learning data item to be used for generation of a cluster model from the sub clusters in the current target main cluster (S108). Here, the model learning section 15b selects, as a learning data item to be used for generation of a cluster model, a learning data item whose center of gravity is closest to the center of gravity of the current target main cluster in the sub cluster whose center of gravity is closest to the center of gravity of the current target main cluster among the sub clusters in the current target main cluster. Furthermore, the model learning section 15b selects, as learning data items to be used for generation of a cluster model, learning data items whose centers of gravity are farthest from the center of gravity of the current target main cluster in the individual sub clusters other than the sub cluster whose center of gravity is closest to the center of gravity of the current target main cluster among the sub clusters in the current target main cluster. Note that the center of gravity of the learning data item is, for example, a document vector of the learning data item.

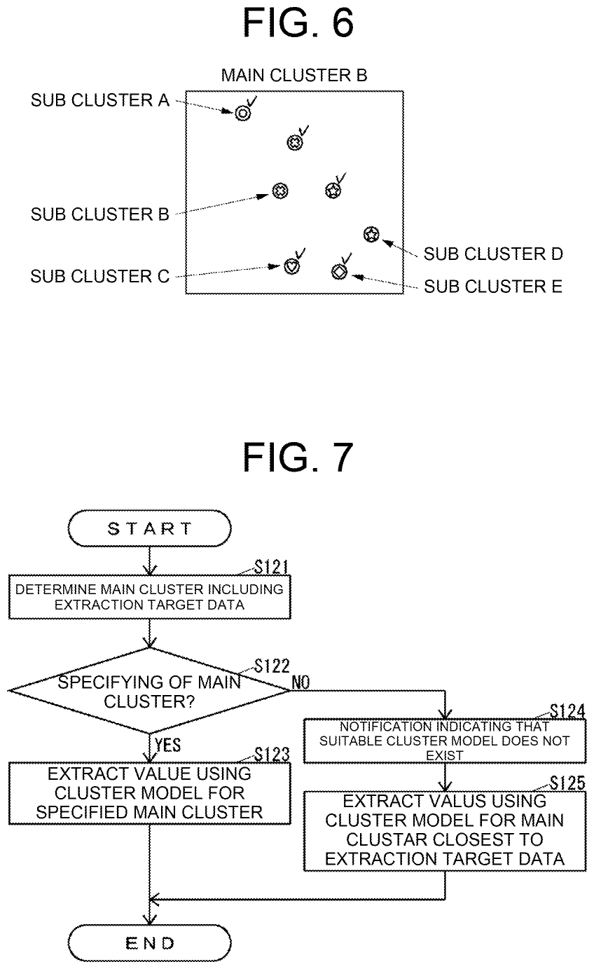

FIG. 6 is a diagram illustrating the process of selecting learning data items to be used for generation of a cluster model in the operation illustrated in FIG. 3. Note that, in FIG. 6, an example of the main cluster B in FIG. 5C is illustrated. In FIG. 6 the learning data items are indicated by marks for the individual sub clusters to which the learning data items belong.

As illustrated in FIG. 6, the model learning section 15b selects, as a learning data item to be used for generation of a cluster model, a learning data item whose center of gravity is closest to the center of gravity of the main cluster B in the sub cluster D whose center of gravity is closest to the center of gravity of the main cluster B among the sub clusters in the main cluster B, and in addition, selects, as a learning data item to be used for generation of a cluster model, learning data items whose centers of gravity are farthest from the center of gravity of the main cluster B in the individual sub clusters other than the sub cluster D in the main cluster B (S108). Note that, in FIG. 6, the learning data items with check marks in upper right corners thereof are selected as the learning data items to be used for generation of a cluster model.

As illustrated in FIG. 3, the model learning section 15b generates, after the process in step S108, a cluster model for the current target main cluster by performing learning using the learning data items selected in step S108 (S109). Here, the model learning section 15b generates a cluster model based on the base model 14b.

After the process in step S109, the document clustering section 15a executes the process in step S103 on one of the main clusters that has not been subjected to the process in step S103 in the current execution of the operation shown in FIG. 3 (S110), when at least one of the main clusters has not yet been subjected to the process in step S103 in the current execution of the operation illustrated in FIG. 3.

After the process in step S109, the model learning section 15b stores, in the storage section 14, all cluster models newly generated in the current execution of the operation illustrated in FIG. 3 (S111) when all the main clusters have been subjected to the process in step S103 in the current execution of the operation illustrated in FIG. 3.

Subsequently, the document clustering section 15a stores a result of the clustering of the main clusters in the operation illustrated in FIG. 3 in a clustering result 14d (S112), and then terminates the operation illustrated in FIG. 3.

Next, an operation of the information extraction system 10 performed when a value of a specific item is extracted from invoice data will be described.

FIG. 7 is a flowchart of an operation of the information extraction system 10 performed when a value of a specific item is extracted from invoice data.

The user may prepare extraction target data and instruct, using the operation section 11 or a computer not illustrated through the communication section 13, the information extraction system 10 to extract a value of a specific item from the prepared extraction target data. Here, the specific item is an item for the correct label in the learning data items used in the generation of a cluster model, i.e., an item desired, by the user, to be extracted from the invoice.

The controller 15 of the information extraction system 10 executes an operation illustrated in FIG. 7 when extraction of a value of a specific item from extraction target data is instructed.

As illustrated in FIG. 7, the document clustering section 15a uses the clustering result 14d to determine a main cluster to which the extraction target data belongs (S121).

After the process in step S121, the data extraction execution section 15c determines whether the main cluster to which the extraction target data belongs has been identified in step S121 (S122).

When determining in step S122 that the main cluster to which the extraction target data belongs has been identified in step S121, the data extraction execution section 15c uses the cluster model for the main cluster determined to include the extraction target data in step S121 to extract a value of the specific item from the invoice data (S123), and then terminates the operation illustrated in FIG. 7.

When determining in step S122 that the main cluster to which the extraction target data belongs has not been identified in step S121, that is, when determining in step S122 that the extraction target data is an outlier that does not belong to any main cluster, the data extraction execution section 15c notifies the user that there is no cluster model suitable for the extraction target data (S124). Here, a method of the notification for the user may be, for example, display in the display section 12 when the extraction of a value for a specific item from the extraction target data is instructed from the operation section 11, or output to a computer, not illustrated, through the communication section 13 when the extraction of a value of a specific item from the extraction target data is instructed from the computer via the communication section 13.

After the process in step S124, the data extraction execution section 15c extracts the value of the specific item from the extraction target data using the cluster model for the main cluster that is closest to the extraction target data (S125), and then terminates the operation illustrated in FIG. 7.

Note that the value extracted in step S123 or step S125 may be used for various purposes. For example, the value extracted in step S123 or step S125 may be used for a file name of an image file of an invoice that is a base of the extraction target data.

Next, an operation of the information extraction system 10 performed when a cluster model is to be updated will be described.

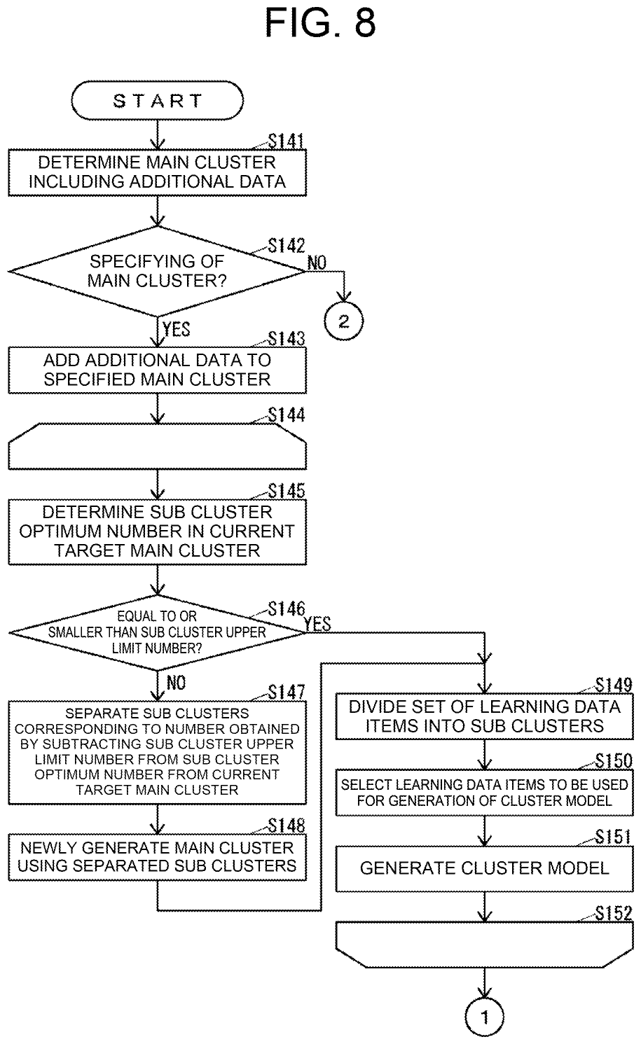

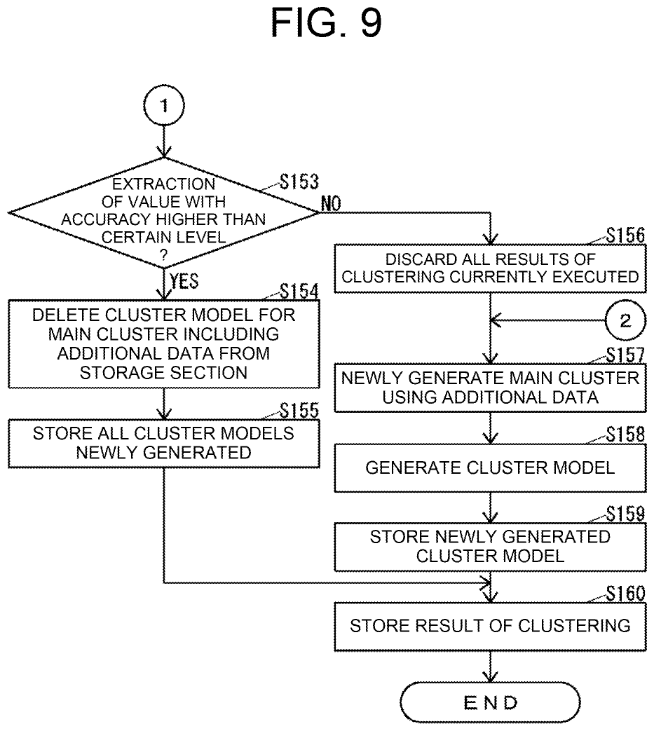

FIG. 8 is a flowchart of a portion of the operation of the information extraction system 10 performed when a cluster model is to be updated. FIG. 9 is a flowchart of an operation following the operation illustrated in FIG. 8.

The user may prepare learning data for updating a cluster model (hereinafter referred to as “additional data”) and instruct, through the operation section 11 or through a computer not illustrated via the communication section 13, the information extraction system 10 to perform learning using the prepared additional data. Here, the user may obtain additional data by assigning a correct label to invoice data whose value extracted using a cluster model was not appropriate, for example.

When the controller 15 of the information extraction system 10 performs the operation illustrated in FIGS. 8 and 9 when learning using the additional data is instructed.

As illustrated in FIGS. 8 and 9, the document clustering section 15a uses the clustering result 14d to determine a main cluster to which the additional data belongs (S141).

After the process in step S141, the document clustering section 15a determines whether the main cluster to which the additional data belongs has been identified in step S141 (S142).

When determining in step S142 that the main cluster to which the additional data belongs has been identified in step S141, the document clustering section 15a adds the additional data to the main cluster determined in step S141 where the additional data belongs (S143).

Thereafter, the document clustering section 15a determines the main cluster determined in step S141 where the additional data belongs as a target (S144).

Thereafter, the document clustering section 15a determines a sub cluster optimum number in the current target main cluster by the cluster number automatic estimation method (S145).

Subsequently, the document clustering section 15a determines whether the sub cluster optimum number determined in step S145 is equal to or smaller than the sub cluster upper limit number (S146).

After the process in step S145, when determining in step S146 that the sub cluster optimum number determined in step S145 is not equal to or smaller than the sub cluster upper limit number, the document clustering section 15a separates a number of the sub clusters corresponding to a number obtained by subtracting the sub cluster upper limit number from the sub cluster optimum number determined in S145 from the current target main cluster (S147). Here, the document clustering section 15a preferentially separates, from the current target main cluster, sub clusters whose centers of gravity are far from the center of gravity of the current target main cluster.

The document clustering section 15a newly generates, after the process in step S147, a main cluster using the sub clusters separated from the current target main cluster in step S147 (S148). Specifically, the document clustering section 15a determines, as a new main cluster, the sub clusters separated from the current target main cluster in step S147.

When determining in step S146 that the optimum number determined in step S145 is equal to or smaller than the sub cluster upper limit number or terminating the process in step S148, the document clustering section 15a performs clustering on the set of learning data items in the current target main cluster by the sub cluster optimum number so as to divide the individual learning data items in the current target main cluster into the sub clusters (S149).

Next, the model learning section 15b selects learning data items to be used for generation of a cluster model from among the sub clusters in the current target main cluster (S150). Here, the model learning section 15b selects, as a learning data item to be used for generation of a cluster model, a learning data item whose center of gravity is closest to the center of gravity of the current target main cluster in the sub cluster whose center of gravity is closest to the center of gravity of the current target main cluster among the sub clusters in the current target main cluster. Furthermore, the model learning section 15b selects, as learning data items to be used for generation of a cluster model, learning data items whose centers of gravity are farthest from the center of gravity of the current target main cluster in the individual sub clusters other than the sub cluster whose center of gravity is closest to the center of gravity of the current target main cluster among the sub clusters in the current target main cluster.

The model learning section 15b generates, after the process in step S150, a cluster model for the current target main cluster by performing learning using the learning data items selected in step S150 (S151). Here, the model learning section 15b generates a cluster model based on the base model 14b.

After the process in step S151, when at least one of the main clusters newly generated in the current execution of the operation illustrated in FIGS. 8 and 9 has not yet been subjected to the process in step S145 in the current execution of the operation illustrated in FIGS. 8 and 9, the document clustering section 15a executes the process in step S145 on one of the main clusters that has not been subjected to the process in step S145 in the current execution of the operation illustrated in FIGS. 8 and 9 in the main clusters newly generated in the current execution of the operation illustrated in FIGS. 8 and 9 (S152).

After the process in step S151, when all the main clusters newly generated in the current execution of the operation illustrated in FIGS. 8 and 9 have been subjected to the process in step S145 in the current execution of the operation illustrated in FIGS. 8 and 9, the data extraction execution section 15c determines whether each of all cluster models newly generated in the current execution of the operation illustrated in FIGS. 8 and 9 is capable of extracting a value of a specific item with accuracy higher than a certain degree for all the learning data items included in the main cluster of a target of the cluster model (S153). Here, whether or not the data extraction execution section 15c can extract a value of a specific item with high accuracy may be determined by the user, or the data extraction execution section 15c itself may automatically make the determination based on a threshold value for the accuracy.

When it is determined in step S153 that each of all the cluster models newly generated in the current execution of the operation illustrated in FIGS. 8 and 9 can extract a value of a specific item with accuracy higher than a certain degree for all the learning data items included in the main cluster of the target of the cluster model itself, the model learning section 15b deletes the cluster model for the main cluster determined in step S141 where the additional data belongs from the storage section 14 (S154) and stores all the cluster models newly generated in the current execution of the operation illustrated in FIGS. 8 and 9 in the storage section 14 (S155).

When it is determined in step S153 that at least one of all the cluster models newly generated in the current execution of the operation illustrated in FIGS. 8 and 9 is not capable of extracting a value of a specific item with accuracy higher than a certain degree for one of the learning data items included in the main cluster of the target of the cluster model itself, the document clustering section 15a discards results of clustering performed in the current execution of the operation illustrated in FIGS. 8 and 9 (S156). Therefore, the document clustering section 15a separates the additional data from the main cluster to which the additional data currently belongs.

When determining in step S142 that the main cluster to which the additional data belongs has not been determined in step S141, that is, when determining in step S142 that the additional data is an outlier that does not belong to any main cluster or when terminating the process in step S156, the document clustering section 15a newly generates a main cluster using the additional data (S157).

The model learning section 15b generates, after the process in step S157, a cluster model for the main cluster to which the additional data belongs by performing learning using the additional data (S158). Here, the model learning section 15b generates a cluster model based on the base model 14b.

After the process in step S158, the model learning section 15b stores the cluster model newly generated in step S158 in the storage section 14 (S159).

After the process in step S155 or step S159, the document clustering section 15a stores a result of the clustering of the main cluster in the operation illustrated in FIGS. 8 and 9 in the clustering result 14d (S160), and then terminates the operation illustrated in FIGS. 8 and 9.

As described above, since the information extraction system 10 generates a cluster model as an information extraction model for each main cluster (S109, S151 and S158), features of each cluster model can be simplified, and as a result, the number of learning data items required for each cluster model can be reduced. Therefore, the information extraction system 10 can reduce an amount of calculation required for generating a cluster model.

Since the information extraction system 10 selects the learning data items to be used for generation of a cluster model for each sub cluster (S108 and S150) and generates a cluster model for each main cluster by performing learning using the selected learning data items (S109 and S151), the number of learning data items required for each cluster model can be reduced, and as a result, an amount of calculation for generating a cluster model can be reduced.

Since the information extraction system 10 selects a learning data item whose center of gravity is closest to the center of gravity of a main cluster in a sub cluster whose center of gravity is closest to the center of gravity of the main cluster as a learning data item to be used for generation of a cluster model (S108 and S150), a cluster model may be generated using a learning data item that most significantly represents features of the main cluster, and as a result, a cluster model in which the features of the main cluster are appropriately reflected may be generated.

Since the information extraction system 10 selects learning data items whose centers of gravity are farthest from the center of gravity of the main cluster in the sub clusters other than the sub cluster whose center of gravity is closest to the center of gravity of the main cluster as learning data items to be used for generation of a cluster model (S108 and S150), a cluster model may be generated using the learning data items dispersed in a large range in the main cluster, and as a result, a cluster model in which the features of the main cluster are appropriately reflected may be generated.

Since the information extraction system 10 separates, when the sub cluster optimum number in the main cluster exceeds the sub cluster upper limit number, a number of sub clusters obtained by subtracting the sub cluster upper limit number from the sub cluster optimum number from the main cluster (S105 and S147), the number of learning data items required for each cluster model may be reduced, and as a result, an amount of calculation for generation of a cluster model may be reduced.

Since the information extraction system 10 preferentially separates from a main cluster, when a number of sub clusters corresponding to a number obtained by subtracting the cluster upper limit number from the cluster optimum number are separated from the main cluster, sub clusters whose centers of gravity are farthest from the center of gravity of the main cluster (S105 and S147), an information extraction model may be generated using learning data items that most significantly represent features of the main cluster, and as a result, an information extraction model in which the features of the main cluster are appropriately reflected may be generated.

Since the information extraction system 10 can reduce an amount of calculation for generating a cluster model, a learning process of deep learning, for example, may be performed even with calculation resources of an ordinary PC. Therefore, the information extraction system 10 can generate a cluster model on a general PC in a local environment without uploading data of a document outside the local environment, when a document from which information is to be extracted is a document, such as an invoice, that includes information that should be protected, such as personal information or transaction information.

According to the description above, when the model learning section 15b updates a cluster model, the cluster model is generated based on the base model 14b. However, when a cluster model is to be updated and the cluster model to be updated has stored in the storage section 14, the model learning section 15b may newly generate a cluster model based on the cluster model to be updated.

According to the description above, the information extraction system 10 extracts information from invoice data. However, the information extraction system 10 is capable of extracting information from data of documents of other types than invoices, such as answer sheets, similarly to the case of invoices. Note that the information extraction system 10 may use different base models for different types of documents or a common base model for different types of documents. Here, the information extraction system 10 can improve the accuracy of information extraction by using different base models for different types of documents rather than using a common base model for different types of documents. However, the information extraction system 10 can reduce the effort of preparing the base model by using a common base model for different types of documents rather than using different base models for different types of documents.

What is claimed is:

1. An information extraction system comprising:
a document clustering section that performs clustering on a set of learning data items to be used to generate information extraction models for extracting information from document data to divide each of the learning data items into any of main clusters; and
a model learning section that generates the information extraction models for the main clusters, respectively, by performing learning using the learning data items for the main clusters, respectively.

2. The information extraction system according to claim 1, wherein
the document clustering section divides each of the learning data items in each of the main clusters into any of sub clusters by performing clustering on the set of the learning data items in the main cluster, and
the model learning section selects the learning data items for use in generation of the information extraction model, for each of the sub clusters, and executes learning using the selected learning data items to generate the information extraction models for the main clusters, respectively.

3. The information extraction system according to claim 2, wherein, in one of the sub clusters whose center of gravity is closest to a center of gravity of the main cluster, the model learning section selects one of the learning data items whose center of gravity is closest to the center of gravity of the main cluster as the learning data to be used for generating the information extraction model.

4. The information extraction system according to claim 3, wherein, in each of the sub clusters other than the sub cluster whose center of gravity is closest to the center of gravity of the main cluster, the model learning section selects one of the learning data items whose center of gravity is farthest from the center of gravity of the main cluster as the learning data to be used for generating the information extraction model.

5. The information extraction system according to claim 2, wherein, the document clustering section determines an optimum number of sub clusters in the main cluster by an automatic cluster number estimation method, and separates from the main cluster, when the determined optimum number exceeds a specified upper limit number, a number of the sub clusters corresponding to a number obtained by subtracting the upper limit number from the optimum number.

6. The information extraction system according to claim 5, wherein the document clustering section preferentially separates from the main cluster, when separating from the main cluster the number of the sub clusters corresponding to the number obtained by subtracting the upper limit number from the optimal number, the sub clusters whose centers of gravity are far from the center of gravity of the main cluster.

7. A non-transitory computer readable recording medium storing an information extraction program that causes a computer to realize:
a document clustering section that performs clustering on a set of learning data items to be used to generate information extraction models for extracting information from document data to divide each of the learning data items into any of main clusters; and
a model learning section that generates the information extraction models for the main clusters, respectively, by performing learning using the learning data items for the main clusters, respectively.
